(19) United States
(12) Patent Application Publication
(10) Pub. No.: US 2010/0073224 A1
(43) Pub. Date: Mar. 25, 2010

(54) Two-way radio handled transceiver capable of wireless reception of location information associated therrewith, and system including the same

(75) Inventor: Hymen Fan, Chung Ho City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: WINTECRONICS, LTD., Chung Ho City (TW)

(21) Appl. No.: 12/378,234

(22) Filed: Feb. 11, 2009

(30) Foreign Application Priority Data
Sep. 22, 2008 (TW) 097136310

(51) Int. Cl. G01S 1/00

(52) U.S. Cl. 342/357.1

(57) ABSTRACT

A system includes a location information-providing device and a two-way radio handheld transceiver. The location information-providing device is operable so as to transmit location information thereof wirelessly. The two-way radio handheld transceiver includes a receiving unit that receives the location information transmitted by the location information-providing device, and a memory unit that stores the location information received by the receiving unit.

### CROSS-REFERENCE TO RELATED APPLICATION

This application claims priority to Taiwanese Application No. 097136310, filed Sep. 22, 2008, the disclosure of which is incorporated herein by reference.

### BACKGROUND OF THE INVENTION

1. Field of the Invention

This invention relates to a two-way radio handheld transceiver, more particularly to a two-way radio handheld transceiver capable of wireless reception of location information associated therewith.

2. Description of the Related Art

A two-way radio handheld transceiver, a.k.a., walkie-talkie, is well known in the art. The conventional two-way radio handheld transceiver has a microphone input port to which a global positioning system (GPS) module may be connected via a cable to thereby permit the conventional two-way radio handheld transceiver to receive location information associated therewith from the GPS module.

It is desirable to provide a two-way radio handheld transceiver capable of wireless reception of location information associated therewith.

### SUMMARY OF THE INVENTION

According to an aspect of the present invention, a system comprises a location information-providing device and a two-way radio handheld transceiver. The location information-providing device is operable so as to transmit location information thereof wirelessly. The two-way radio handheld transceiver includes a receiving unit that receives the location information transmitted by the location information-providing device, and a memory unit that stores the location information received by the receiving unit.

According to another aspect of the present invention, a two-way radio handheld transceiver comprises a receiving unit and a memory unit. The receiving unit is adapted to receive location information associated therewith wirelessly. The memory unit stores the location information received by the receiving unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of the preferred embodiment of a system according to this invention; and

FIG. 2 is a block diagram illustrating a location information-providing device and a two-way radio handheld transceiver of the preferred embodiment.

### DETAILED DESCRIPTION OF THE PREFERRED EMBODIMENT

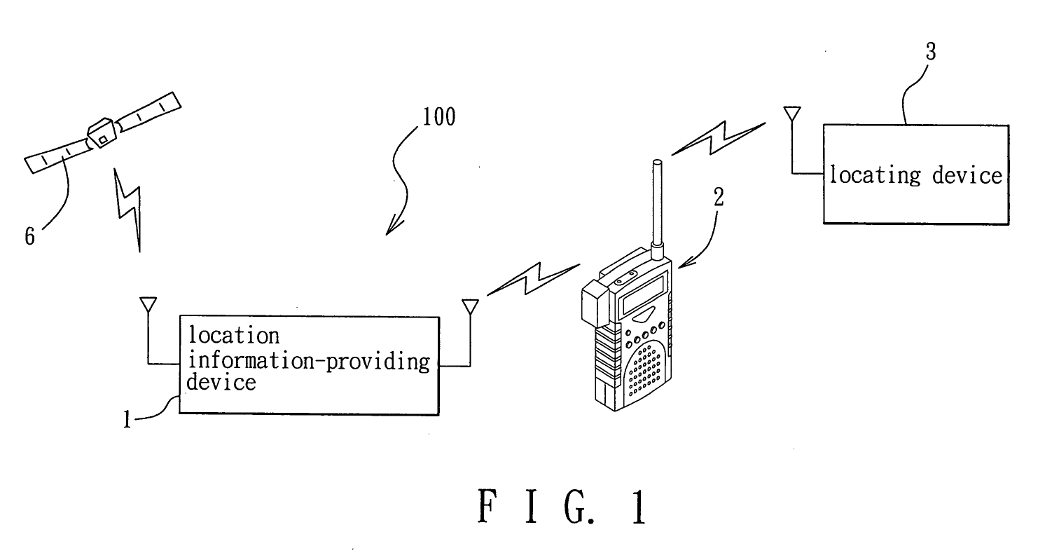

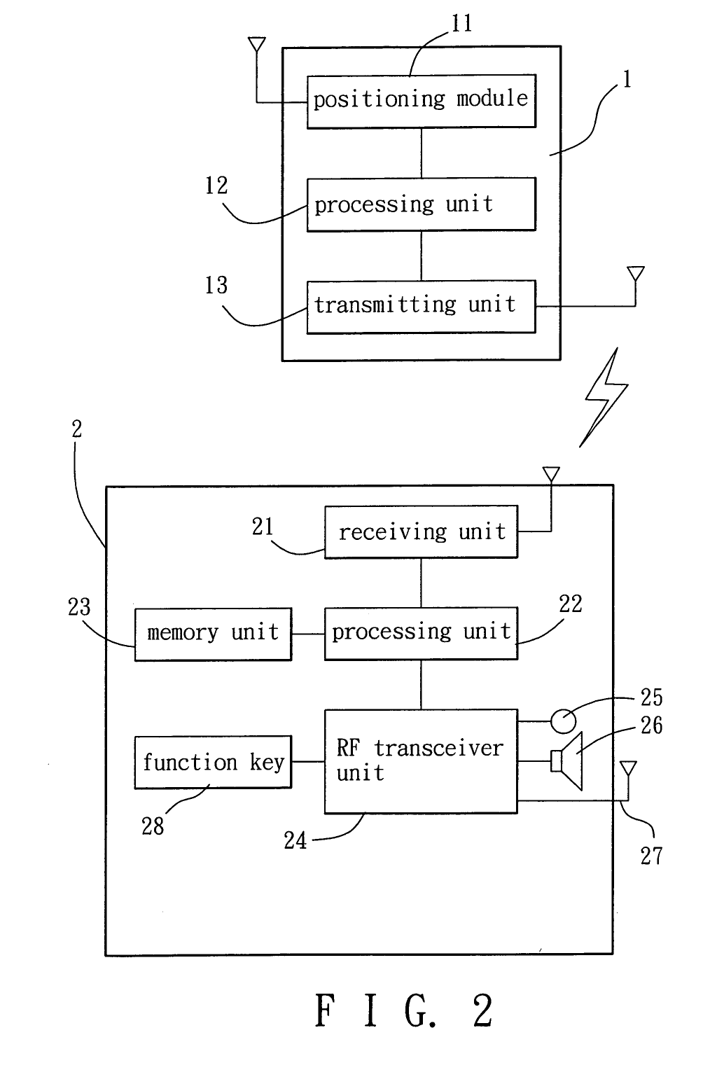

Referring to FIGS. 1 and 2, the preferred embodiment of a system 100 according to this invention is shown to include a location information-providing device 1 and a two-way radio handheld transceiver 2.

The location information-providing device 1 includes a processing unit 12, and a positioning module 11 and a transmitting unit 13, each of which is connected to the processing unit 12. The positioning module 11 is a global positioning system (GPS) receiver, and is operable so as to receive a GPS signal transmitted by a GPS 6, and so as to generate location information of the location information-providing device 1 based on the GPS signal received thereby. The location information includes longitude, latitude, and altitude of the location information-providing device 1. The processing unit 12 is operable so as to generate a location signal, which contains the location information. The transmitting unit 13 is operable so as to transmit the location signal wirelessly.

The two-way radio handheld transceiver 2 includes a processing unit 22, and a receiving unit 21 and a memory unit 23, each of which is connected to the processing unit 22. The receiving unit 21 is operable so as to receive the location signal transmitted by the transmitting unit 13 of the location information-providing device 1. The processing unit 22 is operable so as to extract the location information contained in the location signal received by the receiving unit 21, and so as to store the location information extracted thereby in the memory unit 23.

In this embodiment, the transmitting unit 13 of the location information-providing device 1 is a bluetooth-compliant transmitting unit, and the receiving unit 21 of the two-way radio handheld transceiver 2 is a bluetooth-compliant receiving unit.

In an alternative embodiment, the transmitting unit 13 of the location information-providing device 1 is an infrared-compliant transmitting unit, and the receiving unit 21 of the two-way radio handheld transceiver 2 is an infrared-compliant receiving unit.

It is noted that the receiving unit 21, the processing unit 22, and the memory unit 23 may be implemented as an external module, which is plugged into an input port (not shown) of the two-way radio handheld transceiver 2.

The two-way radio handheld transceiver 2 further includes a radio frequency (RF) transceiver unit 24 connected to the processing unit 22, and a short-wave (SW) antenna 27 connected to the RF transceiver unit 24. The RF transceiver unit 24 is operable so as to transmit via the SW antenna 27 the location information stored in the memory unit 23 to a locating device 3.

The processing unit 22 is capable of being actuated to control the RF transceiver unit 24 to transmit the location information. The two-way radio handheld transceiver 2 further includes a function key 28 that is connected to the RF transceiver unit 24 and that is operable so as to actuate the processing unit 22.

The two-way radio handheld transceiver 2 further includes a microphone 25 and a speaker 26, each of which is connected to the RF transceiver unit 24. The function key 28 is further operable so as to actuate the RF transceiver unit 24 to transmit via the SW antenna 27 a voice signal detected by the microphone 25. The RF transceiver unit 24 is further operable so as to receive via the SW antenna 27 a signal, which is thereafter converted by the speaker 26 into an audible signal.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system, comprising:
a location information-providing device operable so as to transmit location information thereof wirelessly; and
a two-way radio handheld transceiver including
a receiving unit that receives the location information transmitted by said location information-providing device, and
a memory unit that stores the location information received by said receiving unit.

2. The system as claimed in claim 1, wherein said receiving unit is one of an infrared-compliant receiving unit and a bluetooth-compliant receiving unit.

3. The system as claimed in claim 1, wherein said two-way radio handheld transceiver further includes a radio frequency (RF) transceiver unit that is operable so as to transmit the location information stored in said memory unit wirelessly.

4. The system as claimed in claim 3, wherein said two-way radio handheld transceiver further includes a processing unit that is coupled to said RF transceiver unit, and that is operable so as to control said RF transceiver unit to transmit the location information.

5. The system as claimed in claim 4, wherein said processing unit is capable of being actuated to control said RF transceiver unit to transmit the location information.

6. The system as claimed in claim 5, wherein said two-way radio handheld transceiver further includes a function key that is coupled to said RF transceiver unit and that is operable so as to actuate said processing unit.

7. The system as claimed in claim 1, wherein said location information-providing device includes:
a positioning module that generates the location information;
a processing unit that is coupled to said positioning module, and that is operable so as to generate a location signal, which contains the location information; and
a transmitting unit that is coupled to said processing unit, and that is operable so as to transmit the location signal wirelessly.

8. The system as claimed in claim 7, wherein said transmitting unit of said location information-providing device is one of an infrared-compliant transmitting unit and a bluetooth-compliant transmitting unit.

9. The system as claimed in claim 1, wherein said location information-providing device includes a global positioning system (GPS) receiver.

10. A two-way radio handheld transceiver, comprising:
a receiving unit adapted to receive location information associated therewith wirelessly; and
a memory unit storing the location information received by said receiving unit.

11. The two-way radio handheld transceiver as claimed in claim 10, wherein said receiving unit is one of an infrared-compliant receiving unit and a bluetooth-compliant receiving unit.

12. The two-way radio handheld transceiver as claimed in claim 10, further comprising a radio frequency (RF) transceiver unit operable so as to transmit the location information stored in said memory unit wirelessly.

13. The two-way radio handheld transceiver as claimed in claim 12, further comprising a processing unit coupled to said RF transceiver unit, and operable so as to control said RF transceiver unit to transmit the location information.

14. The two-way radio handheld transceiver as claimed in claim 13, wherein said processing unit is capable of being actuated to control said RF transceiver unit to transmit the location information.

15. The two-way radio handheld transceiver as claimed in claim 14, further comprising a function key coupled to said RF transceiver unit and operable so as to actuate said processing unit.

16. The two-way radio handheld transceiver as claimed in claim 13, further comprising an input port,
said receiving unit, said processing unit, and said memory unit being implemented as an external module, which is plugged into said input port.
